(19) United States
(12) Patent Application Publication
(10) Pub. No.: US 2019/0305993 A1
(43) Pub. Date: Oct. 3, 2019

(54) ETHERNET COMMUNICATION CIRCUIT CAPABLE OF AVOIDING PHYSICAL LAYER CIRCUIT FROM CRASH CAUSED BY SURGE EVENT

(71) Applicant: Realtek Semiconductor Corp., Hsinchu (TW)

(72) Inventors: Jui-Yu WU, Hsinchu County (TW); Ting-Fa YU, Hsinchu County (TW); Cheng-Cheng YEN, Hsinchu County (TW); Wen-Fu WANG, Taichung City (TW)

(73) Assignee: Realtek Semiconductor Corp., Hsinchu (TW)

(21) Appl. No.: 16/371,569

(22) Filed: Apr. 1, 2019

(30) Foreign Application Priority Data
Apr. 3, 2018 (TW) 107111863

(51) Int. Cl. H04L 25/08; H04L 25/02

(52) U.S. Cl. CPC H04L 25/08; H04L 25/0272; H04L 25/0266

(57) ABSTRACT

An Ethernet communication circuit includes: an Ethernet cable connector for communicating data with other devices through an Ethernet cable; an Ethernet transformer coupled with the Ethernet cable connector and arranged to operably process signals transmitted from the Ethernet cable connector; an Ethernet physical layer circuit coupled with the Ethernet transformer and arranged to operably conduct physical layer operations on the signals transmitted from the Ethernet transformer; and a plurality of coupling capacitors respectively arranged between a portion of signal pins of the Ethernet physical layer circuit and the Ethernet transformer.

### CROSS-REFERENCE TO RELATED APPLICATIONS

This application claims the benefit of priority to Patent Application No. 107111863, filed in Taiwan on Apr. 3, 2018; the entirety of which is incorporated herein by reference for all purposes.

### BACKGROUND

The disclosure generally relates to an Ethernet communication circuit and, more particularly, to an Ethernet communication circuit capable of avoiding a physical layer circuit from crash caused by a transient voltage surge event.

A transient voltage surge may cause damage to the physical layer circuit in the Ethernet communication circuit. Therefore, many manufacturers of the physical layer circuit install various transient voltage surge protection circuits in the physical layer circuit, so as to improve the physical layer circuit's ability to resist the transient voltage surge.

However, although a conventional physical layer circuit can utilize an internal transient voltage surge protection circuit to absorb the impact of the transient voltage surge to thereby prevent the physical layer circuit from damaged, the transient voltage surge still often cause the physical layer circuit to crash.

### SUMMARY

An example embodiment of an Ethernet communication circuit capable of avoiding a physical layer circuit from crash due to a transient voltage surge is disclosed. The Ethernet communication circuit comprising: an Ethernet cable connector arranged to operably communicate data with other devices through an Ethernet cable; an Ethernet transformer coupled with the Ethernet cable connector and arranged to operably process signals transmitted from the Ethernet cable connector; an Ethernet physical layer circuit coupled with the Ethernet transformer and arranged to operably conduct physical layer operations on signals transmitted from the Ethernet transformer; and a plurality of coupling capacitors respectively arranged between the Ethernet transformer and partial signal pins of the Ethernet physical layer circuit.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of an Ethernet communication circuit according to one embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

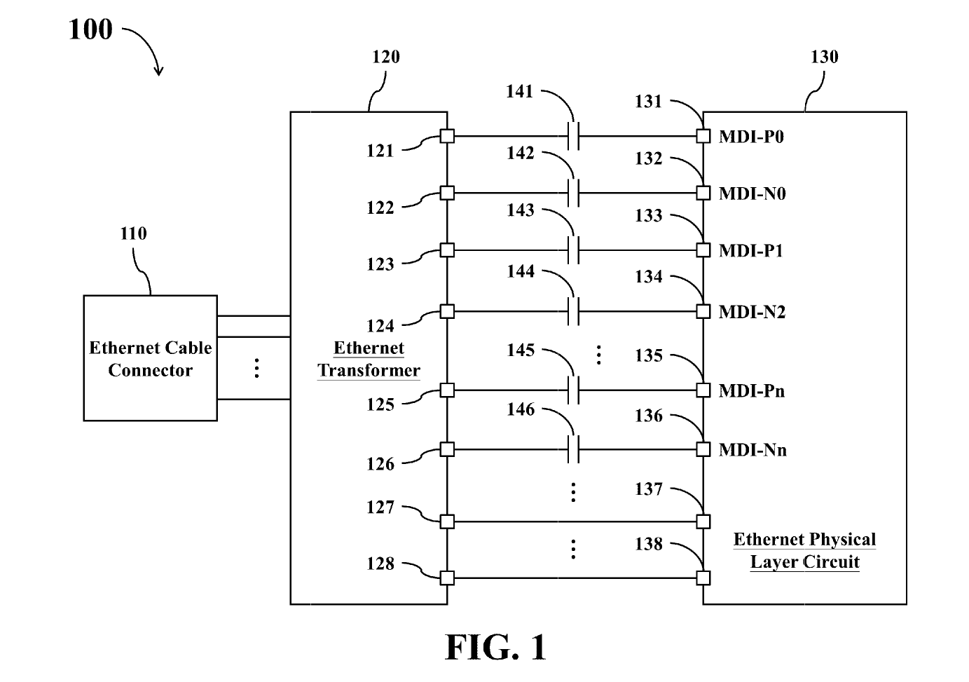

FIG. 1 shows a simplified functional block diagram of an Ethernet communication circuit 100 according to one embodiment of the present disclosure. The Ethernet communication circuit 100 comprises an Ethernet cable connector 110, an Ethernet transformer 120, an Ethernet physical layer circuit 130, and a plurality of coupling capacitors.

The Ethernet cable connector 110 is utilized to communicate data with other devices through an Ethernet cable. In practice, the Ethernet cable connector 110 can be realized with an Ethernet cable male connector or an Ethernet cable female connector.

The Ethernet transformer 120 is coupled with the Ethernet cable connector 110. The Ethernet transformer 120 is arranged to operably conduct voltage isolation and filtering operations on signals transmitted from the Ethernet cable connector 110, so as to suppress noise and achieve impedance matching.

The Ethernet physical layer circuit 130 is coupled with the Ethernet transformer 120, and arranged to operably conduct a physical layer operation on signals transmitted from the Ethernet transformer 120. As described in the foregoing descriptions, a transient voltage surge protection circuit can be installed inside the Ethernet physical layer circuit 130 to avoid the Ethernet physical layer circuit 130 from being damaged by the transient voltage surge.

In practice, the Ethernet cable connector 110, the Ethernet transformer 120, and the Ethernet physical layer circuit 130 may be realized with various existing circuits. The Ethernet communication circuit 100 may be realized with various Ethernet cards, hubs, switches, and routers, etc.

As described above, although the transient voltage surge protection circuit in the Ethernet physical layer circuit 130 can avoid the Ethernet physical layer circuit 130 from being damaged by the transient voltage surge, the transient voltage surge may still cause the Ethernet physical layer circuit 130 crash.

To prevent the above situation, in this embodiment, a plurality of additional coupling capacitors are arranged between the Ethernet transformer 120 and partial signal pins of the Ethernet physical layer circuit 130. That is, the plurality of coupling capacitors are arranged outside the Ethernet transformer 120 and the Ethernet physical layer circuit 130.

The Ethernet communication circuit 100 in this embodiment comprises a plurality of coupling capacitors 141˜146. The plurality of coupling capacitors 141˜146 are respectively arranged between partial signal pins 131˜136 of the Ethernet physical layer circuit 130 and corresponding signal pins 121˜126 of the Ethernet transformer 120.

The coupling capacitor 141 is coupled between the signal pin 131 of the Ethernet physical layer circuit 130 and the corresponding signal pin 121 of the Ethernet transformer 120 in a series connection. The coupling capacitor 142 is coupled between the signal pin 132 of the Ethernet physical layer circuit 130 and the corresponding signal pin 122 of the Ethernet transformer 120 in a series connection. The coupling capacitor 143 is coupled between the signal pin 133 of the Ethernet physical layer circuit 130 and the corresponding signal pin 123 of the Ethernet transformer 120 in a series connection. The coupling capacitor 144 is coupled between the signal pin 134 of the Ethernet physical layer circuit 130 and the corresponding signal pin 124 of the Ethernet transformer 120 in a series connection. The coupling capacitor 145 is coupled between the signal pin 135 of the Ethernet physical layer circuit 130 and the corresponding signal pin 125 of the Ethernet transformer 120 in a series connection. The coupling capacitor 146 is coupled between the signal pin 136 of the Ethernet physical layer circuit 130 and the corresponding signal pin 126 of the Ethernet transformer 120 in a series connection.

When the transient voltage surge event occurs, the coupling capacitors 141˜146 block direct current on respective signal paths, and thus the impact to the Ethernet physical layer circuit 130 caused by surge current incurred by the transient voltage surge can be reduced. In other words, the coupling capacitors 141˜146 provide additional transient voltage surge protection to the Ethernet physical layer circuit 130.

According to practical experience, the possibility of that the Ethernet physical layer circuit 130 crashes due to the transient voltage surge can be reduced to a minimum level by arranging the aforementioned additional coupling capacitors between the Ethernet transformer 120 and MDI (medium dependent interface) signal pins of the Ethernet physical layer circuit 130.

Therefore, in the Ethernet physical layer circuit 130, the signal pins 131˜136 that are coupled with the coupling capacitors 141˜146 may be MDI signal pins. For example, the signal pins 131 and 132 may be a pair of differential MDI signal pins, the signal pins 133 and 134 may be another pair of differential MDI signal pins, while the signal pins 135 and 136 may be another pair of differential MDI signal pins. In one embodiment where the Ethernet physical layer circuit 130 supports auto MDI/MDIX functionalities, the Ethernet physical layer circuit 130 may flexibly configure the functions of the above signal pins 131˜136.

In practice, the plurality of aforementioned coupling capacitors 141˜146 have substantially the same capacitance. Please note that in some embodiments, the Ethernet transformer 120 or the Ethernet physical layer circuit 130 may comprise a number of built-in capacitors, but the capacitance of the coupling capacitors 141˜146 is typically much bigger than the built-in capacitors. Thus, the coupling capacitors 141˜146 are not suitable to be integrated into the Ethernet transformer 120 or the Ethernet physical layer circuit 130, in order to avoid significantly increasing the circuit area or package volume of the Ethernet transformer 120 or the Ethernet physical layer circuit 130.

In addition, there is no need to arrange similar coupling capacitors between other signal pins 137-138 of the Ethernet physical layer circuit 130 and corresponding signal pins 127-128 of the Ethernet transformer 120. In other words, the coupling capacitors 141˜146 only need to be arranged between partial signal pins of the Ethernet physical layer circuit 130 and corresponding pins of the Ethernet transformer 120.

It can be appreciated from the foregoing descriptions that the impact to the Ethernet physical layer circuit 130 caused by the transient voltage surge can be effectively reduced by arranging additional coupling capacitors 141˜146 between the Ethernet transformer 120 and the partial signal pins 131˜136 of the Ethernet physical layer circuit 130, thereby reducing the possibility of that the Ethernet physical layer circuit 130 crashes due to the transient voltage surge.

In addition, the possibility of that the Ethernet physical layer circuit 130 crashes due to the transient voltage surge can be reduced to a minimum level by arranging the aforementioned additional coupling capacitors 141˜146 between the MDI signal pins of the Ethernet physical layer circuit 130 and the Ethernet transformer 120 and.

Furthermore, since the aforementioned additional capacitors 141˜146 can provide additional transient voltage surge protection, there is no need to arrange more complicated transient voltage surge protection circuit in the Ethernet physical layer circuit 130. Therefore, the circuitry area requirement of the Ethernet physical layer circuit 130 can be reduced effectively.

Please note that the aforementioned circuit structure disclosed in FIG. 1 is merely an example embodiment, rather than a restriction to practical implementations. For example, the quantity of MDI signal pins in the Ethernet physical layer circuit 130 is not limited to the number shown in FIG. 1. In practice, the quantity of MDI signal pins in the Ethernet physical layer circuit 130 can be increased or decreased depending upon the circuitry requirement.

In addition, it may arrange additional coupling capacitors merely between partial MDI signal pins of the Ethernet physical layer circuit 130 and corresponding pins of the Ethernet transformer 120 in some embodiments where the transient voltage surge has less impact or lower occurring possibility.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The term “couple” is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. An Ethernet communication circuit (100) capable of avoiding a physical layer circuit from crash due to a transient voltage surge, the Ethernet communication circuit (100) comprising:
an Ethernet cable connector (110) arranged to operably communicate data with other devices through an Ethernet cable;
an Ethernet transformer (120) coupled with the Ethernet cable connector (110) and arranged to operably process signals transmitted from the Ethernet cable connector (110);
an Ethernet physical layer circuit (130) coupled with the Ethernet transformer (120) and arranged to operably conduct physical layer operations on signals transmitted from the Ethernet transformer (120); and
a plurality of coupling capacitors (141˜146) respectively arranged between the Ethernet transformer (120) and partial signal pins (131˜136) of the Ethernet physical layer circuit (130).

2. The Ethernet communication circuit (100) of claim 1, wherein the plurality of coupling capacitors (141˜146) are only arranged between the Ethernet transformer (120) and partial signal pins (131˜136) of the Ethernet physical layer circuit (130).

3. The Ethernet communication circuit (100) of claim 2, wherein the plurality of coupling capacitors (141˜146) have substantially same capacitance.

4. The Ethernet communication circuit (100) of claim 2, wherein the plurality of coupling capacitors (141˜146) are only arranged between the Ethernet transformer (120) and a plurality of MDI (medium dependent interface) signal pins (131˜136) of the Ethernet physical layer circuit (130).

5. The Ethernet communication circuit (100) of claim 4, wherein the plurality of coupling capacitors (141˜146) have substantially same capacitance.

6. The Ethernet communication circuit (100) of claim 1, wherein the plurality of coupling capacitors (141˜146) have substantially same capacitance.
